(19) United States
(12) Patent Application Publication
(10) Pub. No.: US 2010/0167010 A1
(43) Pub. Date: Jul. 1, 2010

(54) PLANING COAT AND METHOD FOR PRODUCING THE SAME

(76) Inventor: Yohsuke Takeuchi, Kanagawa (JP)

Correspondence Address: BIRCH STEWART KOLASCH & BIRCH, PO BOX 747, FALLS CHURCH, VA, 22040-0747, US

(21) Appl. No.: 12/294,775

(22) PCT Filed: Mar. 27, 2007
(86) PCT No.: PCT/JP2007/057350

§ 371 Date: Sep. 26, 2008

(30) Foreign Application Priority Data
Mar. 30, 2006 (JP) 2006-094828
Jul. 31, 2006 (JP) 2006-207998

(51) Int. Cl. B32B 3/30; B32B 17/10; B32B 27/06; C08F 212/08; C08L 25/08

(52) U.S. Cl. 428/141; 428/441; 428/451; 525/242

(57) ABSTRACT

A planing coat includes a copolymer having a hydrocarbon vinyl monomer as a copolymer component, which is formed on a base material and has a slipping rate of 0.5 cm/second or more, the slipping rate being calculated by adding 50 μl of distilled water to a sample mounted on a horizontal surface with a slant of 15 degree so as to form a droplet, and measuring the period of time of the droplet to travel 90 mm under an environment of 20±5° C. in temperature and 50±10% in relative humidity.

### TECHNICAL FIELD

This invention relates to a coat having large planing property and a method for producing the same.

### BACKGROUND ART

Conventionally, techniques for adding water repellency by a chemical treatment, such as coating of the solid surface with a fluorine resin or a silicon resin, are well known. On the other hand, techniques which take note of not only such a water repellency but also slipping of water drops on the base surface have also been known. For example, a technique for improving slipping of water drops by using a mixture of a hydrophilic organic silicon compound having a hydrophilic group (methanesulfonyl group) and a hydrophobic organic silicon compound has been described in JP-A-2000-008026 (the term “JP-A” as used herein means an “unexamined published Japanese patent application”) , and that by increasing introduced amount of a silicon compound onto the base surface in JP-A-2000-144056.

In addition, JP-A-2005-132919 describes that a high planing coat can be obtained by treating the base surface with a surface treating agent which comprises a water repellent binder resin such as a fluorine resin, a dispersing agent such as a water and oil repellent agent and a low calorific capacity particle such as carbon black.

### DISCLOSURE OF THE INVENTION

A first object of the present invention is to provide a novel technique for forming a high slipping coat, which is different from the conventional water slipping surface forming methods. Furthermore, the second object of the present is to provide a technique for conveniently obtaining an excellent water slipping surface using an inexpensive material.

The present inventors have conducted intensive studies and found as a result that a markedly high planing coat can be obtained by surface-forming on a base using a hydrocarbon polymer, thereby resulting in the accomplishment of the invention. That is, construction of the invention is as follows.

(1) According to a first aspect of the present invention, a planing coat comprising a copolymer having a hydrocarbon vinyl monomer as a copolymer component, which is formed on a base material and has a slipping rate of 0.5 cm/second or more, the slipping rate being calculated by adding 50μl of distilled water to a sample mounted on a horizontal surface with a slant of 15 degree so as to form a droplet, and measuring the period of time of the droplet to travel 90 mm under an environment of 20±5° C. in temperature and 50±10% in relative humidity.
(2) The planing coat as described in the item (1), wherein the hydrocarbon vinyl monomer comprises styrene.
(3) The planing coat as described in the item (1) or (2), wherein the hydrocarbon vinyl monomer is contained in an amount of 50% by mass or more based on the copolymer.
(4) The planing coat as described in any one of the items (1) to (3), wherein the copolymer comprises a block copolymer.
(5) The planing coat as described in any one of the items (1) to (4), wherein the copolymer component comprises a monomer which is more hydrophilic than the hydrocarbon vinyl monomer.
(6) The planing coat as described in the item (5), wherein the copolymer contains a hydrophilic polymer in an amount of 30% by mass or less based on the copolymer.
(7) The planing coat as described in any one of the items (1) to (6), which has a surface roughness of 100 nm or less.
(8) According to a second aspect of the present invention, a method for producing a planing coat which comprises a coating composition including a copolymer, wherein the copolymer comprises: a hydrocarbon vinyl monomer; and another polymer that does not involve the hydrocarbon polymer as a copolymer component.
(9) The method for producing the planing coat as described in the item (8), wherein the hydrocarbon vinyl monomer is contained in an amount of 50% by mass or more based on the copolymer.
(10) The method for producing the planing coat as described in the item (8) or (9), wherein the hydrocarbon vinyl monomer comprises styrene.
(11) The method for producing the planing coat as described in any one of the items (8) to (10), wherein the coating composition comprises polystyrene.
(12) The method for producing the planing coat as described in any one of the items (8) to (11), wherein the coating composition comprises a solvent.
(13) The method for producing the planing coat as described in the item (12), wherein the solvent is an aromatic solvent.
(14) According to a third aspect of the present invention, a planing coat formed by a method according to any one of the items (8) to (13).

The slipping rate of the invention was calculated by (slipping rate)=(traveling length/time) , by adding 50μl of distilled water dropwise to a sample mounted on a horizontal surface with a slant of 15 degree, thereby forming a drop of water, and measuring the period of time of the drop of water to travel 90 mm, carried out under an environment of 20±5° C. in temperature and 50±10% in relative humidity. The coat of the invention having large planting property has the aforementioned slipping rate of 0.5 cm/second or more, preferably 0.7 cm/second or more, more preferably 1.0 cm/second or more.

According to the invention, a high planing coat having a slipping rate of 0.5 cm/second or more can be obtained conveniently and inexpensively.

### BEST MODE FOR CARRYING OUT THE INVENTION

The coat of the invention having high planing property is formed on a base. The base is not particularly limited, and any base consisting of an inorganic substance or a high polymer or the like organic substance can be used. As the base consisting of an inorganic substance, a base in which glass, silicon, aluminum, stainless steel, a metal such as gold, silver, copper or the like, or a metal oxide such as ITO, tin oxide, alumina, titanium oxide or the like is arranged on its surface can be used.

Also, as the high polymer base, a base consisting of polyethylene, polypropylene, polystyrene, cellulose diacetate, cellulose triacetate, cellulose propionate, cellulose butyrate, cellulose acetate, cellulose nitrate, polyethylene terephthalate, polycarbonate, polyvinyl acetal, polyurethane, epoxy resin, polyester resin, acrylic resin or polyimide can be used.

These high polymer bases may be bases to which a corona treatment, a plasma treatment or the like pretreatment was applied or in which fine irregularities were arranged on their surfaces, in order to improve adhesiveness with the coat having large planing property to be arranged on the bases. Shape of the base is not particularly limited.

The hydrocarbon polymer has a mass content of carbon and hydrogen of preferably 70% or more, more preferably 90% or more. For example, polystyrene, polyethylene, polypropylene, polybutadiene or a mixture thereof can be cited.

Among them, a vinyl system monomer containing an aromatic hydrocarbon is desirable, and styrene is particularly desirable.

The coat of the invention contains a vinyl system monomer other than the hydrocarbon vinyl monomer, as a copolymer component. In order to obtain good planing surface, the hydrocarbon vinyl monomer is contained in an amount of preferably 50% by mass or more, more preferably 70% by mass or more, particularly preferably 90% by mass or more, based on the total copolymers. The copolymer of the invention maybe either a random copolymer or a block copolymer, but in order to obtain excellent high slipping property, a block copolymer is desirable.

As the polymer other than the hydrocarbon polymer, it is desirable to select a polymer which shows hydrophilic property in comparison with the polymer of hydrocarbon vinyl monomer. As such a polymer, illustratively, polymethyl methacrylate, polybutyl methacrylate, polymethacrylate and the like poly(meth)acrylic acid esters, polylactic acid, PET and the like polyesters, or polyimide, polysulfone, polyimide, polyketone and the like polymers can be exemplified.

According to the invention, when a hydrophilic monomer is contained as a copolymer component, the hydrophilic monomer is contained in an amount of preferably 30% by mass or less, more preferably 20% by mass or less, particularly preferably 5% by mass or less, based on the copolymer.

In addition, a low molecular compound other than the polymers may be added for the purpose of improving physical properties, and its examples include 4-butyl-2-methylphenol, methylenebis (2,4-dimethylphenol) and the like akylphenol compounds, stearic acid amide, palmitic acid amide and the like amide compounds, diethylene glycol dimethyl ether and the like ether compounds, and dibutyl thioether, phenyloctyl thioether and the like thioether compounds.

It is desirable to add these low molecular compounds at a concentration of 1% by weight or less as the solid component concentration in order to improve physical properties without spoiling the planing property.

The coat of the invention having large planting can be formed almost smoothly, but a minute irregularity may be arranged on the surface. However, in the case of optical applications or when a shade of the coat becomes a problem, it is desirable that the minute irregular layer has an average surface roughness Ra of 100 nm or less.

In this connection, the “average roughness Ra” is a parameter standard-equipped for general surface roughness testers and can be measured easily by a general surface roughness tester. The “average roughness Ra” generally means height of the median line when standard deviation of the distance from the bottom to the top of a minute irregularity is considered. Since scattering of light generally becomes significant from a size of approximately from 1/10 to ⅕ of wavelength, and the wavelength of visible light is mainly from about 400 to 800 nm, it is desirable to control the average roughness (Ra) of the surface of a substance at a level of 100 nm or less, more preferably 50 nm or less, in order to ensure transparency within this wavelength range.

The method for forming a high planning coat containing the copolymer of the invention on a base is not particularly limited, and its examples include application, deposition, sticking, crimping and the like. Preferred is a method in which a coating solution containing a hydrocarbon polymer is prepared, applied to a base and then dried.

As the applying method, dipping and pulling up, spraying, spin coating, curtain coating and the like conventionally known application means can be used.

The coating solution can be used by diluting it with an organic solvent or the like, in response to a necessity such as of the application method. Regarding the organic solvent to be used, it may be used alone or as a mixture of two or more species, with the proviso that the compound contained in the coating solution can be uniformly dissolved therein. For example, methanol, ethanol, normal propyl alcohol, normal butyl alcohol and the like primary alcohols, isopropyl alcohol, isobutyl alcohol and the like secondary alcohols, tertiary butyl alcohol and the like tertiary alcohols, ethylene glycol, ethylene glycol monomethyl ether, ethylene glycol monoethyl ether, diethylene glycol monomethyl ether, diethylene glycol monoethyl ether and the like glycols, methyl acetate, ethyl acetate and the like esters, diethyl ether, diisopropyl ether, di-tertiary butyl ether and the like ethers, acetone, methyl ethyl ketone, cyclohexanone and the like ketones, toluene, xylene, mesitylene and the like aromatic system solvents and the like general solvents can be cited.

In addition, in order to improve adhesiveness with the base, it is desirable to remove soil of the base surface by taking away impurities on the base, prior to the formation of the aforementioned high planing coat containing a hydrocarbon polymer. The removing method is not particularly limited, and its examples include blasting with a gas, alkali washing, UV/ozone treatment, plasma treatment and the like. Particularly, alkali washing, UV/ozone treatment or plasma treatment is desirable from the viewpoint that sufficient effect can be obtained and the operation is easy and simple.

Since the high planning coat of the invention can easily slip away minute water drops, it can be effectively applied to tools, devices, facilities, constructions, parts thereof and the like, which have a possibility of generating damages, reducing functions or exerting troubles upon. human due to accretion of ice or snow. Their illustrative examples include various types of antenna, communication cables and the like outdoor electrical communication instruments, ship or train windowpane, deck, step, outside packing and the like transport vehicle members and roof tile, tile, windowpane and the like structures, as well as a solar panel cover and the like.

### EXAMPLES

The following demonstrates the invention based on examples, but the invention is not limited to these examples.

### Inventive Example 1

A 10 cm square white plate glass (0.7 mm in thickness) was exposed to a UV ozone cleaner (NL-UV 253, mfd. by Japan Laser Electronics Co., Ltd.) for 5 minutes . A toluene solution containing 1% by mass of a polystyrene/polymethyl methacrylate copolymer (copolymerization ratio (molar ratio) 2.4/1: mfd. by POLYMER SOURCE) was applied thereto by spin coating (700 rpm, 20 seconds) and then dried at room temperature for 10 minutes and then at 100° C. for 20 minutes.

When this base was observed under an AFM, an almost smooth coat with no irregularity was obtained.

The thus prepared base was slanted to an angle of 15°, and 50 μl of water was dropped from a height of 1 cm onto the upper end of the base. When sliding-down period of time until it slid down to the opposite end was measured 5 times, it was 1.0 seconds.

### Inventive Example 2

A base was prepared by the method of Inventive Example 1, except that a silicon base was used instead of the glass base of Inventive Example 1.

The thus prepared base was slanted to an angle of 15° , and 50 μl of water was dropped from a height of 1 cm onto the upper end of the base. When sliding-down period of time until it slid down to the opposite end was measured 5 times, it was 1.0 seconds.

### Comparative Example 1

A base was prepared by the method of Inventive Example 1, except that a toluene solution containing 1% by mass of a mixture of polystyrene/polymethyl methacrylate=⅕ was used instead of the toluene solution of Inventive Example 1 containing 1% by mass of the polystyrene/polymethyl methacrylate copolymer (mfd. by POLYMER SOURCE).

The thus prepared base was slanted to an angle of 15°, and 50 μl of water was dropped from a height of 1 cm onto the upper end of the base. When sliding-down period of time until it slid down to the opposite end was measured 5 times, it was 6.0 seconds.

### Inventive Example 3

A solution A was prepared by mixing a toluene solution containing 1% by mass of a polystyrene/polymethyl methacrylate copolymer (copolymerization ratio (molar ratio) 2.4/1: mfd. by POLYMER SOURCE) with a toluene solution containing 1% by mass of polystyrene at a ratio of 1:3 (mass ratio).

A 10 cm square white plate glass (0.7 mm in thickness) was exposed to a UV ozone cleaner (NL-UV 253, mfd. by Japan Laser Electronics Co., Ltd.) for 5 minutes. The solution A. prepared in the above was applied onto the glass by spin coating (3,000 rpm, 30 seconds) and then dried at room temperature for 10 minutes and then at 100° C. for 30 minutes.

The thus prepared base was slanted to an angle of 15°, and 50 μl of water was dropped from a height of 1 cm onto the upper end of the base. When sliding-down period of time until it slid down to the opposite end was measured 5 times, it was 3.2 seconds.

### Inventive Example 4

A solution A was prepared by mixing a toluene solution containing 1% by mass of a polystyrene/polymethyl methacrylate copolymer (copolymerization ratio (molar ratio) 2.4/1: mfd. by POLYMER SOURCE) with a toluene solution containing 1% by mass of polystyrene at a ratio of 1:27 (mass ratio).

A 10 cm square white plate glass (0.7 mm in thickness) was exposed to a UV ozone cleaner (NL-UV 253, mfd. by Japan Laser Electronics Co., Ltd.) for 5 minutes. The solution A. prepared in the above was applied onto the glass by spin coating (3,000 rpm, 30 seconds) and then dried at room temperature for 10 minutes and then at 100° C. for 30 minutes.

The thus prepared base was slanted to an angle of 15° , and 50 μl of water was dropped from a height of 1 cm onto the upper end of the base. When sliding-down period of time until it slid down to the opposite end was measured 5 times, it was 3.3 seconds.

### Inventive Example 5

A solution A was prepared by mixing a toluene solution containing 1% by mass of a polystyrene/polymethyl methacrylate copolymer (copolymerization ratio (molar ratio) 2.4/1: mfd. by POLYMER SOURCE) with a toluene solution containing 1% by mass of polystyrene at a ratio of 1:2,100 (mass ratio).

A 10 cm square white plate glass (0.7 mm in thickness) was exposed to a UV ozone cleaner (NL-UV 253, mfd. by Japan Laser Electronics Co., Ltd.) for 5 minutes. The solution A. prepared in the above was applied onto the glass by spin coating (3,000 rpm, 30 seconds) and then dried at room temperature for 10 minutes and then at 100° C. for 30 minutes.

The thus prepared base was slanted to an angle of 15°, and 50 μl of water was dropped from a height of 1 cm onto the upper end of the base. When sliding-down period of time until it slid down to the opposite end was measured 5 times, it was 3.3 seconds.

### Inventive Example 6

A solution A was prepared by mixing a toluene solution containing 1% by mass of a polystyrene/polymethyl methacrylate copolymer (copolymerization ratio (molar ratio) 2.4/1: mfd. by POLYMER SOURCE) with a toluene solution containing 1% by mass of polystyrene at a ratio of 1:6, 600 (mass ratio).

A 10 cm square white plate glass (0.7 mm in thickness) was exposed to a UV ozone cleaner (NL-UV 253, mfd. by Japan Laser Electronics Co., Ltd.) for 5 minutes. The solution A prepared in the above was applied onto the glass by spin coating (3,000 rpm, 30 seconds) and then dried at room temperature for 10 minutes and then at 100° C. for 30 minutes.

The thus prepared base was slanted to an angle of 15° , and 50 μl of water was dropped from a height of 1 cm onto the upper end of the base. When sliding-down period of time until it slid down to the opposite end was measured 5 times, it was 3.5 seconds.

### Comparative Example 3

A 10 cm square white plate glass (0.7 mm in thickness) was exposed to a UV ozone cleaner (NL-UV 253, mfd. by Japan Laser Electronics Co., Ltd.) for 5 minutes. A toluene solution containing 1% by mass of polystyrene was applied thereto by spin coating (3,000 rpm, 30 seconds) and then dried at room temperature for 10 minutes and then at 100° C. for 30 minutes.

The thus prepared base was slanted to an angle of 15° , and 50 μl of water was dropped from a height of 1 cm onto the upper end of the base. When sliding-down period of time until it slid down to the opposite end was measured 5 times, it did not slide down to the opposite end.

### Comparative Example 4

A solution A was prepared by mixing a toluene solution containing 1% by mass of a polystyrene/polymethyl methacrylate copolymer (copolymerization ratio (molar ratio) 2.4/1: mfd. by POLYMER SOURCE) with a toluene solution containing 1% by mass of polymethyl methacrylate at a ratio of 9:1 (mass ratio). A 10 cm square white plate glass (0.7 mm in thickness) was exposed to a UV ozone cleaner (NL-UV 253, mfd. by Japan Laser Electronics Co., Ltd.) for 5 minutes. The solution A. prepared in the above was applied onto the glass by spin coating (3,000 rpm, 30 seconds) and then dried at room temperature for 10 minutes and then at 100° C. for 30 minutes.

When the thus prepared base was slanted to an angle of 15°, and 50 μl of water was dropped from a height of 1 cm onto the upper end of the base, the droplet did not slide down after its dropping onto the base.

1. A planing coat comprising a copolymer having a hydrocarbon vinyl monomer as a copolymer component, which is formed on a base material and has a slipping rate of 0.5 cm/second or more, the slipping rate being calculated by adding 50 μl of distilled water to a sample mounted on a horizontal surface with a slant of 15 degree so as to form a droplet, and measuring the period of time of the droplet to travel 90 mm under an environment of 20±5° C. in temperature and 50±10% in relative humidity.

2. The planing coat as claimed in claim 1, wherein the hydrocarbon vinyl monomer comprises styrene.

3. The planing coat as claimed in claim 1, wherein the hydrocarbon vinyl monomer is contained in an amount of 50% by mass or more based on the copolymer.

4. The planing coat as claimed in claim 1, wherein the copolymer comprises a block copolymer.

5. The planing coat as claimed in claim 1, wherein the copolymer component comprises a monomer which is more hydrophilic than the hydrocarbon vinyl monomer.

6. The planing coat as claimed in claim 5, wherein the copolymer contains a hydrophilic polymer in an amount of 30% by mass or less based on the copolymer.

7. The planing coat as claimed in claim 1, which has a surface roughness of 100 nm or less.

8. A method for producing a planing coat which comprises a coating composition including a copolymer,
wherein
the copolymer comprises:
a hydrocarbon vinyl monomer; and
another polymer that does not involve the hydrocarbon polymer as a copolymer component.

9. The method for producing the planing coat as claimed in claim 8, wherein the hydrocarbon vinyl monomer is contained in an amount of 50% by mass or more based on the copolymer.

10. The method for producing the planing coat as claimed in claim 8, wherein the hydrocarbon vinyl monomer comprises styrene.

11. The method for producing the planing coat as claimed in claim 8, wherein the coating composition comprises polystyrene.

12. The method for producing the planing coat as claimed in claim 8, wherein the coating composition comprises a solvent.

13. The method for producing the planing coat as claimed in claim 12, wherein the solvent is an aromatic solvent.

14. A planing coat formed by a method according to claim 8.
